(19) United States
(12) Patent Application Publication
(10) Pub. No.: US 2026/0194647 A1
(43) Pub. Date: Jul. 9, 2026

(54) RADAR APPARATUS, DATA PROCESSING METHOD, AND DATA PROCESSING PROGRAM

(71) Applicant: Furuno Electric Co., Ltd., Nishinomiya (JP)

(72) Inventor: Hironori TAKAHASHI, Nishinomiya (JP)

(21) Appl. No.: 19/558,243

(22) Filed: Mar. 5, 2026

Related U.S. Application Data
(63) Continuation of application No. PCT/JP2024/029273, filed on Aug. 19, 2024.

(30) Foreign Application Priority Data
Oct. 4, 2023 (JP) 2023-172459

(51) Int. Cl. G01S 13/58; G01S 7/06; G01S 13/42; G01S 13/89

(52) U.S. Cl. CPC G01S 13/58; G01S 7/06; G01S 13/42; G01S 13/89

(57) ABSTRACT

To separate and display a plurality of target objects in close proximity in an echo image while reducing capacity of a memory for displaying the echo image. A radar apparatus is provided with a transmitter transmits electromagnetic waves; a receiver receives reflected electromagnetic waves; processing circuitry generates amplitude data of the reflected electromagnetic waves and displacement data indicating velocity or acceleration of the target object, and determines whether a cell of interest corresponds to a boundary cell to divide the target object based on a comparison result between the displacement data of the cell of interest and the displacement data of the cell of interest being close to the cell of interest in an azimuthal direction or a distance direction.

### CROSS-REFERENCE TO RELATED APPLICATION(S

This application is a continuation application of PCT International Application No. PCT/JP2024/029273, which was filed on August 19, 2024, and which claims priority to Japanese Patent Application No. JP2023-172459 filed on October 4, 2023, the entire disclosures of each of which are herein incorporated by reference for all purposes.

### TECHNICAL FIELD

The present invention relates to a radar apparatus, data processing method, and data processing program.

### BACKGROUND ART

Conventionally, in a radar apparatus that displays an echo image of a target object, a technology has been developed to improve resolution of a detection result of the target object.

### SUMMARY

It is desirable to have a technology capable of separating and displaying a plurality of target objects in close proximity in the echo image while reducing the memory capacity necessary for displaying the echo image.

To provide a radar apparatus, a data processing method, and a data processing program capable of displaying the plurality of target objects in close proximity separately in the echo image while reducing a memory capacity necessary for displaying the echo image.

(1) In order to solve the above-mentioned problem, the radar apparatus, according to an aspect of the present invention, is provided with a transmitter configured to transmit electromagnetic waves; a receiver configured to receive reflected electromagnetic waves reflected by a target object; processing circuitry configured to generate amplitude data of the reflected electromagnetic waves and displacement data indicating the velocity or acceleration of the target object based on the reflected electromagnetic waves for each cell on a coordinate having an azimuthal direction and a distance direction, and determine whether a cell of interest corresponds to a boundary cell to be a boundary to divide the target object based on a comparison result between the displacement data of the cell of interest among the plurality of cells of interest and the displacement data of the cell of interest being close to the cell of interest in the azimuthal direction or the distance direction.

In this way, the processing circuitry (i.e., determination procedure or determination processing) configured to determine whether the cell of interest corresponds to the boundary cell is performed based on the comparison result between the displacement data of the cell of interest and the displacement data of the cell adjacent to the cell of interest in the azimuthal direction or the distance direction, so that the determination procedure may be performed using the displacement data of a smaller number of cells compared with the configuration using the displacement data of two cells adjacent to each other across the cell of interest, thereby reducing the memory capacity required for storing the displacement data used for the determination procedure. Based on the result of the determination procedure, the plurality of target objects adjacent to each other may be separated and displayed in the echo image. Accordingly, the plurality of target objects adjacent to each other may be separated and displayed in the echo image while reducing the memory capacity required for displaying the echo image.

(2) In (1) above, the processing circuitry may determine whether the cell of interest corresponds to the boundary cell on the basis of the comparison result between the displacement data of the cell of interest and the displacement data of the cell in proximity to the cell of interest in the azimuthal direction, and the comparison result between the displacement data of the cell of interest and the displacement data of the cell in proximity to the cell of interest in the distance direction.

With this configuration, it may be possible to more accurately determine whether the cell of interest corresponds to the boundary cell.

(3) In (2) above, the processing circuitry may determine that the cell of interest corresponds to the boundary cell when the absolute value of the difference between the displacement data of the cell of interest and the displacement data of the cell adjacent to the cell of interest in the azimuthal direction is not less than a predetermined value and the absolute value of the difference between the displacement data of the cell of interest and the displacement data of the cell adjacent to the cell of interest in the distance direction is not less than the predetermined value.

With this configuration, it is possible to determine by simple process whether the cell of interest corresponds to the boundary cell using a preset threshold.

(4) In any of the above (1) to (3), the transmitter may repeatedly transmit the electromagnetic waves while changing the transmission direction of the electromagnetic waves along a first direction among the azimuthal directions, and the processing circuitry is further configured to determine whether the cell of interest corresponds to the boundary cell based on the comparison result between the displacement data of the cell of interest and the displacement data of the cell adjacent to the cell of interest in a direction opposite to the first direction in the determination procedure.

With this configuration, it is possible to sequentially generate the displacement data of the cells in each column along the first direction and determine whether the cell belonging to the latest column corresponds to the boundary cell, so that the delay in the display of the echo image using the amplitude data may be suppressed by performing the determination procedure.

(5) In (4) above, the processing circuitry may determine, while changing a cell set as the cell of interest along a second direction among the distance directions, whether the cell of interest corresponds to the boundary cell based on the comparison result between the displacement data of the cell of interest and the displacement data of the cell adjacent to the cell of interest in the second direction.

With this configuration, it is possible to suppress the determination that the cell at a leading edge (i.e., front edge) of the target object on the radar apparatus side in the distance direction is the boundary cell in the determination procedure, and therefore, based on the result of the determination procedure, it is possible to more correctly recognize the boundary of the target object on the radar apparatus side of the target object located at the back of the target object from the viewpoint of the radar apparatus among the two adjacent target objects in the echo image.

(6) In any of the above (1) to (5), the processing circuitry may attenuate the amplitude indicated by the amplitude data of the cell of interest determined to correspond to the boundary cell.

With this configuration, the echo image may be generated based on the amplitude data with the amplitude attenuated, the plurality of target objects in close proximity may be separated and displayed.

(7) In order to solve the above-mentioned problem, a data processing method, according to the aspect of the present invention, in the radar apparatus includes transmitting electromagnetic waves; receiving reflected electromagnetic waves reflected by a target object; generating amplitude data of the reflected electromagnetic waves and displacement data indicating the velocity or acceleration of the target object based on the reflected electromagnetic waves for each cell on a coordinate having an azimuthal direction and a distance direction; and determining whether the cell of interest corresponds to a boundary cell to be a boundary to divide a target object based on a comparison result between the displacement data of the cell of interest among a plurality of cells of interest and the displacement data of the cell of interest being close to the cell of interest in the azimuthal direction or the distance direction.

According to this aspect, the method for determining whether the cell of interest corresponds to the boundary cell based on the comparison result between the displacement data of the cell of interest and the displacement data of the cell adjacent to the cell of interest in the azimuthal direction or the distance direction may perform the determination procedure using the displacement data of a smaller number of cells compared with the method using the displacement data of two cells adjacent to each other across the cell of interest, so that a memory capacity required for storing the displacement data used for the determination procedure may be reduced. Based on the result of the determination procedure, a plurality of target objects adjacent to each other may be separated and displayed in the echo image. Accordingly, the plurality of target objects adjacent to each other may be separated and displayed in the echo image while reducing the memory capacity required for displaying the echo image.

(8) In order to solve the above-mentioned problem, a data processing program, according to a certain aspect of the present invention, to be installed in a radar apparatus, wherein the computer executes the processing of transmitting electromagnetic waves; receiving reflected electromagnetic waves reflected by a target object; generating amplitude data of the reflected electromagnetic waves and displacement data indicating the velocity or acceleration of the target object based on the reflected electromagnetic waves for each cell on a coordinate having an azimuthal direction and a distance direction; and determining whether a cell of interest corresponds to a boundary cell to be a boundary to divide the target object based on a comparison result between the displacement data of the cell of interest among a plurality of cells of interest and the displacement data of the cell of interest being close to the cell of interest in the azimuthal direction or the distance direction.

According to this aspect, the determination module configured to determine whether the cell of interest corresponds to the boundary cell may be performed based on the comparison result between the displacement data of the cell of interest and the displacement data of the cell adjacent to the cell of interest in the azimuthal direction or the distance direction, so that the determination procedure may be performed using the displacement data of a smaller number of cells compared with the configuration using the displacement data of two cells adjacent to each other across the cell of interest, thereby reducing the memory capacity required for storing the displacement data used for the determination procedure. Based on the result of the determination procedure, a plurality of target objects adjacent to each other may be separated and displayed in the echo image. Accordingly, the plurality of target objects adjacent to each other may be separated and displayed in the echo image while reducing the memory capacity required for displaying the echo image.

According to the present invention, the plurality of target objects in close proximity may be separated and displayed in an echo image while reducing the memory capacity required for displaying the echo image.

### BRIEF DESCRIPTION OF DRAWINGS

FIG. 1 is a diagram showing a radar detection range of a radar apparatus according to an embodiment of the present invention.

FIG. 2 is a diagram showing an example of an echo image displayed by the radar apparatus according to an embodiment of the present invention.

FIG. 3 is a diagram showing a configuration of the radar apparatus according to an embodiment of the present invention.

FIG. 4 is a diagram for explaining a processing configured to generate amplitude data and velocity data by a generation module in the radar apparatus according to an embodiment of the present invention.

FIG. 5 is a diagram for explaining an example of a determination procedure by a data processor module in the radar apparatus according to an embodiment of the present invention.

FIG. 6 is a diagram showing an example of the determination procedure and a correction processing by a data processor module in a radar apparatus according to an embodiment of the present invention.

FIG. 7 is a diagram showing an example of a determination procedure and a correction processing by a radar apparatus according to a comparative example of the present invention.

FIG. 8 is a diagram showing another example of the determination procedure and a correction processing by the data processor module in the radar apparatus according to an embodiment of the present invention.

FIG. 9 is a diagram showing another example of the determination procedure and the correction processing by the data processor module in the radar apparatus according to an embodiment of the present invention.

FIG. 10 is a diagram showing another example of the determination procedure and the correction processing by the data processor module in the radar apparatus according to the embodiment of the present invention.

FIG. 11 is a diagram showing another example of the determination procedure and the correction processing by the data processor module in the radar apparatus according to the embodiment of the present invention.

FIG. 12 is a diagram showing another example of the determination procedure and the correction processing by the data processor module in the radar apparatus according to a comparative example of the present invention.

FIG. 13 is a diagram showing another example of the determination procedure and the correction processing by the data processor module in the radar apparatus according to the comparative example of the present invention.

FIG. 14 is a diagram showing another example of the determination procedure and the correction processing by the data processor module in the radar apparatus according to the comparative example of the present invention.

FIG. 15 is a diagram showing another example of the determination procedure and the correction processing by the data processor module in the radar apparatus according to the comparative example of the present invention.

FIG. 16 is a diagram for explaining another example of the determination procedure by the data processor module in the radar apparatus according to an embodiment of the present invention.

FIG. 17 is a diagram showing an example of the determination procedure and correction processing by the data processor module in the radar apparatus according to an embodiment of the present invention.

FIG. 18 is a diagram showing an example of the determination procedure and correction processing by the data processor module in the radar apparatus according to an embodiment of the present invention.

FIG. 19 is a diagram showing an example of the determination procedure and correction processing by the data processor module in the radar apparatus according to an embodiment of the present invention.

FIG. 20 is a diagram showing an example of the determination procedure and correction processing by the data processor module in the radar apparatus according to an embodiment of the present invention.

FIG. 21 is a diagram for explaining another example of the determination procedure by the data processor module in the radar apparatus according to an embodiment of the present invention.

FIG. 22 is a diagram showing an example of the determination procedure and correction processing by the data processor module in the radar apparatus according to an embodiment of the present invention.

FIG. 23 is a diagram showing an example of the determination procedure and correction processing by the data processor module in the radar apparatus according to an embodiment of the present invention.

FIG. 24 is a diagram showing an example of the determination procedure and correction processing by the data processor module in the radar apparatus according to an embodiment of the present invention.

FIG. 25 is a diagram showing an example of the determination procedure and correction processing by a data processor module in a radar apparatus according to an embodiment of the present invention.

FIG. 26 is a diagram showing an example of the determination procedure and correction processing by the data processor module in the radar apparatus according to an embodiment of the present invention.

FIG. 27 is a diagram for explaining another example of the determination procedure by the data processor module in the radar apparatus according to an embodiment of the present invention.

FIG. 28 is a diagram showing an example of the determination procedure and correction processing by the data processor module in the radar apparatus according to an embodiment of the present invention.

FIG. 29 is a diagram showing an example of the determination procedure and correction processing by the data processor module in the radar apparatus according to an embodiment of the present invention.

FIG. 30 is a diagram showing an example of the determination procedure and correction processing by the data processor module in the radar apparatus according to an embodiment of the present invention.

FIG. 31 is a diagram showing an example of the determination procedure and correction processing by the data processor module in the radar apparatus according to an embodiment of the present invention.

FIG. 32 is a diagram showing the advantages and disadvantages according to the adjacent cells used in the determination procedure by the data processor module in the radar apparatus according to the embodiment of the present invention.

FIG. 33 is a flowchart showing an example of an operation in which the radar apparatus performs a processing of displaying an echo image according to an embodiment of the present invention.

FIG. 34 is a flowchart showing an example of an operation in which the radar apparatus performs determination procedure according to an embodiment of the present invention.

### DETAILED DESCRIPTION

Hereinafter, an embodiment of the present invention will be described with reference to the drawings. The same reference numerals are used for the same or equivalent portions in the drawings, and the description is not repeated. In addition, at least a portion of the following embodiments may be optionally combined.

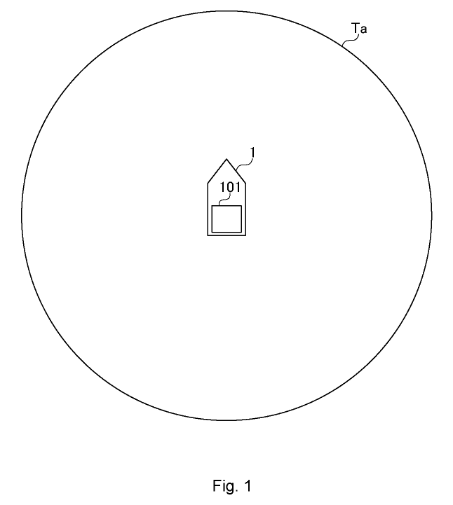

Configuration and Basic Operation - FIG. 1 is a diagram showing a radar detection range of a radar apparatus (101), according to an embodiment of the present invention. Referring to FIG. 1, a radar apparatus (101) is mounted on a ship (1). The radar apparatus (101) transmits electromagnetic waves to a radar detection range (Ta) and receives reflected electromagnetic waves reflected by the transmitted electromagnetic waves. Based on the received electromagnetic waves, the radar apparatus (101) performs processing to display on a display device (not shown) an echo image indicating the presence or absence of a target object (S) of another ship or the like in the radar detection range (Ta) and the distance between the radar apparatus (101) and the target object (S). For example, the radar detection range (Ta) is an area inside a circle of a predetermined size centered on the ship (1).

For example, during a sweep period (T) of a predetermined length, the radar apparatus (101) transmits electromagnetic waves to a divided target area (Da), which is a portion of the radar detection range (Ta), and receives reflected electromagnetic waves reflected by the transmitted electromagnetic waves. The radar apparatus (101) repeats the transmission of the electromagnetic waves and the reception of the reflected electromagnetic waves while changing the azimuth angle of the transmission direction of the electromagnetic waves by a predetermined angle every sweep period (T). Hereinafter, when the radar apparatus (101) changes the azimuth angle of the transmission direction of the electromagnetic waves by the predetermined angle, it is also called “sweep ”.

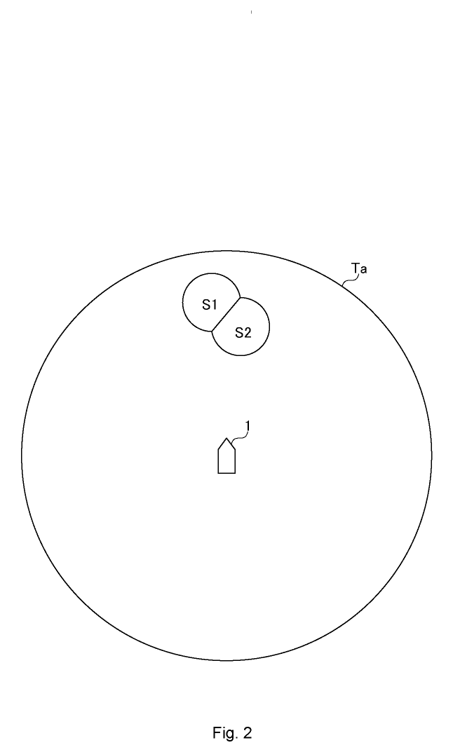

FIG. 2 is a diagram showing an example of an echo image displayed by the radar apparatus (101), according to an embodiment of the present invention. Referring to FIG. 2, when target objects (S1) and (S2) are close to each other in the radar detection range (Ta), the target objects (S1) and (S2) may be displayed as one target object (S) in the echo image. In this case, a user of the radar apparatus (101) may not distinguish and recognize target objects (S1) and (S2) based on the displayed echo image.

In such a case, where the target objects (S) are close to each other, it is desirable to have a technology that may separate and display a plurality of target objects (S) close to each other in the echo image while reducing a memory capacity necessary for displaying the echo image. Therefore, the radar apparatus (101), according to the embodiment of the present invention, may solve the above-mentioned problem by the following configuration.

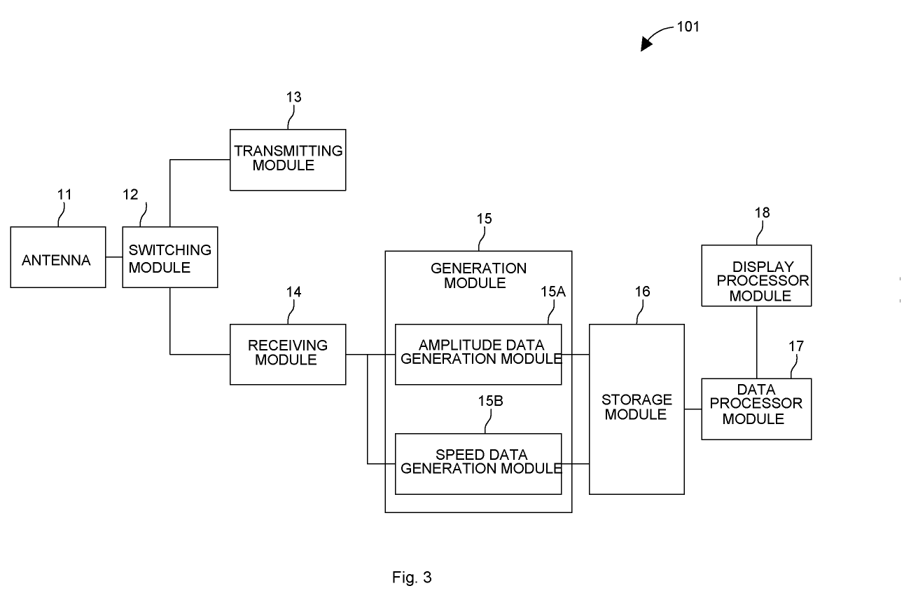

FIG. 3 is a diagram showing a configuration of the radar apparatus (101), according to the embodiment of the present invention. Referring to FIG. 3, the radar apparatus (101) includes an antenna (11), a switching module (12), a transmitting module (13), a receiving module (14), a generation module (15), a storage module (16), a data processor module (17), and a display processor module (18). The generation module (15) includes an amplitude data generation module (15A) and a speed (i.e., velocity) data generation module (15B). The data processor module (17) is an example of a determination module and an example of an attenuation module. Some or all of the switching module (12), the transmitting module (13), the receiving module (14), the generation module (15), the data processor module (17), and the display processer module (18) are implemented, for example, by a processing circuit (Circuitry) including one or more processors. The storage module (16) is, for example, a nonvolatile memory included in the processing circuit.

The switching module (12) alternatively switches between a state in which the antenna (11) and the transmitting module (13) are connected and a state in which the antenna (11) and the receiving module (14) are connected. The switching module (12) connects the antenna (11) and the transmitting module (13) during a transmission period (Tt) of the electromagnetic waves in the sweep period (T), and connects the antenna (11) and the receiving module (14) during a reception period (Tr) of the reflected electromagnetic waves in the sweep period (T).

The transmitting module (13) transmits the electromagnetic waves to the divided target area (Da) via the switching module (12) and the antenna (11) during the transmission period (Tt).

For example, the transmitting module (13) repeatedly transmits the electromagnetic waves while changing the transmission direction of the electromagnetic waves along the direction of the sweep in the azimuth direction. Hereinafter, the direction of the sweep is also referred to as a sweep direction. The sweep direction is a direction along the azimuth direction, for example, a clockwise direction. The sweep direction is an example of a first direction. The transmission direction of the electromagnetic waves is an example of the second direction, and is a direction away from the ship (1). More specifically, the antenna (11) rotates along the sweep direction so that the azimuth angle of the transmission direction of the electromagnetic waves changes by a predetermined angle every sweep period (T). The transmitting module (13) transmits the electromagnetic waves to a different divided target area (Da) every sweep period (T) through the switching module (12) and the antenna (11).

The receiving module (14) receives the reflected electromagnetic waves reflected by the electromagnetic waves at the target object (S). More specifically, the receiving module (14) receives the reflected electromagnetic waves reflected by the electromagnetic waves at the target object (S) in the divided target area (Da) via the antenna (11) and the switching module (12) during the reception period (Tr). The receiving module (14) generates the received data by digitally converting the received reflected electromagnetic waves at each reception period (Tr), and outputs the generated received data to the generation module (15).

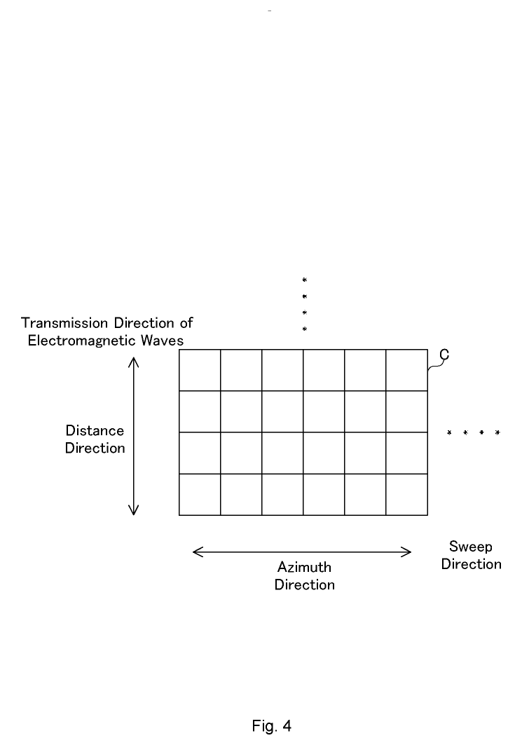

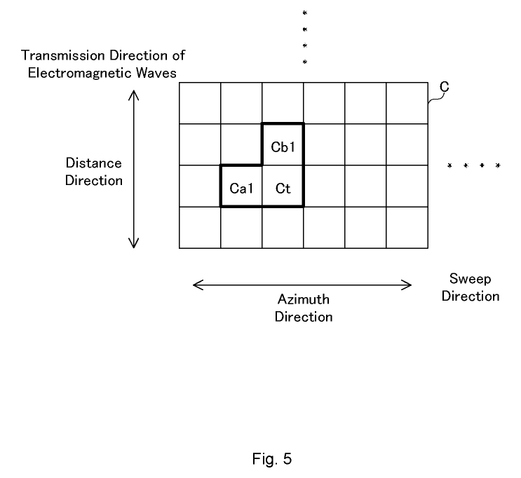

FIG. 4 is a diagram for explaining generation processing of amplitude data and velocity data by the generation module in the radar apparatus (101), according to an embodiment of the present invention. FIG. 4 shows a plurality of cells (C) arranged in a matrix on two-dimensional coordinates corresponding to the radar detection range (Ta). For example, one column of cells (C) in two-dimensional coordinates corresponds to the divided target area (Da). In practice, the azimuthal direction is a direction on a curve and the shape of the cell (C) is represented by a curve, but in FIG. 4, the azimuthal direction is a direction on a straight line and the shape of the cell (C) is a square. The same may be applied in FIG. 5 and later.

Referring to FIG. 4, the generation module (15) generates the amplitude data of the reflected electromagnetic waves and the velocity data indicating the velocity of the target object (S) for each cell (C) on the coordinates having the azimuth direction and the distance direction based on the reflected electromagnetic waves received by the receiving module (14). The velocity data is an example of the displacement data.

More specifically, the amplitude data generation module (15A) in the generation module (15) receives the received data from the receiving module (14) and generates amplitude data indicating the amplitude of the reflected electromagnetic waves reflected at the position corresponding to the cell (C) based on the received data. For example, the amplitude data generation module (15A) generates one column of amplitude data of the cell (C) each time it receives the received data from the receiving module (14). The amplitude data generation module (15A) stores the generated amplitude data in the storage module (16) in association with the cell (C) each time it generates amplitude data of one cell (C). The amplitude data generation module (15A) may binarize the amplitude of the reflected electromagnetic waves reflected at the position corresponding to the cell (C) by using a predetermined threshold value and generate amplitude data indicating the binarized amplitude.

The speed data generation module (15B) in the generation module (15) receives the received data from the receiving module (14) and generates velocity data indicating the velocity of the target object (S) at the position corresponding to the cell (C) based on the received data. More specifically, the speed data generation module (15B) calculates a Doppler velocity of the target object (S) at the position corresponding to the cell (C) based on the received data, for example, according to a pulse pair method. For example, the speed data generation module (15B) generates one column of velocity data of the cell (C) each time it receives the received data from the receiving module (14). Each time the velocity data of one cell (C) is generated, the speed data generation module (15B) stores the generated velocity data in the storage module (16) in association with the cell (C).

Based on the velocity data stored in the storage module (16) by the speed data generation module (15B), the data processor module (17) performs determination procedure to determine whether the cell (C) in the two-dimensional coordinate corresponds to a boundary cell (Cx), which is the boundary cell (Cx) to be a boundary (BD) to divide a target object (S).

FIG. 5 is a diagram for explaining an example of determination procedure by the data processor module (17) in the radar apparatus (101), according to an embodiment of the present invention. Referring to FIG. 5, the data processor module (17) compares the velocity data of a cell of interest (Ct) among the plurality of cells (C) with the velocity data of the cell (C) adjacent to the cell of interest (Ct) in the azimuthal direction. The cell (C) adjacent to the cell of interest (Ct) in the azimuthal direction is, for example, a cell (C) having less than a certain constant aligned in the azimuthal direction from the cell of interest (Ct). For example, the data processor module (17) compares the velocity data of the cell of interest (Ct) with the velocity data of an adjacent cell (Ca1), which is the cell (C) adjacent to the cell of interest (Ct) in the direction opposite to the sweep direction.

The data processor module (17) also compares the velocity data of the cell of interest (Ct) with the velocity data of the cell (C) adjacent to the cell of interest (Ct) in the distance direction. The cell (C) adjacent to the cell of interest (Ct) in the distance direction is, for example, the cell (C) of less than a certain number aligned in the distance direction from the cell of interest (Ct). For example, the data processor module (17) compares the velocity data of the cell of interest (Ct) with the velocity data of an adjacent cell (Cb1) which is the cell (C) adjacent to the cell of interest (Ct) in the transmission direction of the electromagnetic waves.

The data processor module (17) determines whether the cell of interest (Ct) corresponds to the boundary cell (Cx) on the basis of the comparison result between the velocity data of the cell of interest (Ct) and the velocity data of the adjacent cell (Ca1), and the comparison result between the velocity data of the cell of interest (Ct) and the velocity data of the adjacent cell (Cb1).

For example, in the determination procedure, the data processor module (17) determines that the cell of interest (Ct) corresponds to the boundary cell (Cx) if the absolute value of the difference between the Doppler velocity indicated by the velocity data of the cell of interest (Ct) and the Doppler velocity indicated by the velocity data of the adjacent cell (Ca1) is not less than a predetermined value or if the absolute value of the difference between the Doppler velocity indicated by the velocity data of the cell of interest (Ct) and the Doppler velocity indicated by the velocity data of the adjacent cell (Cb1) is not less than the predetermined value.

The data processor module (17) performs correction processing for attenuating the amplitude indicated by the amplitude data of the cell of interest (Ct) determined to correspond to the boundary cell (Cx). More specifically, the data processor module (17) corrects the amplitude indicated by the amplitude data of the cell (C) determined to correspond to the boundary cell (Cx) in the storage module (16) to 0 in the correction processing.

For example, the data processor module (17) performs the determination procedure while changing the cell (C) to be set as the cell of interest (Ct) along the transmission direction of the electromagnetic waves. More specifically, the data processor module (17) performs the determination procedure and the correction processing for each column of the cell (C). The data processor module (17) performs the determination procedure and the correction processing for each cell (C) while changing the cell (C) to be set as the cell of interest (Ct) among the cells (C) of a target column along the transmission direction of the electromagnetic waves from the cell (C) of the most ship (1).

In the determination procedure, the data processor module (17) may use the velocity data of the cell (C) adjacent to the adjacent cell (Ca1) in the direction opposite to the sweep direction instead of the velocity data of the adjacent cell (Ca1). In the determination procedure, the data processor module (17) may use the average value of the Doppler velocity indicated by the velocity data of the constant cell (C) adjacent to the cell (Ct) in the direction opposite to the sweep direction instead of the Doppler velocity indicated by the velocity data of the adjacent cell (Ca1).

The data processor module (17) may use the velocity data of the cell (C) adjacent to the adjacent cell (Cb1) in the transmission direction of the electromagnetic waves instead of the velocity data of the adjacent cell (Cb1) in the determination procedure. The data processor module (17) may use the average value of the Doppler velocity indicated by the velocity data of the constant cell (C) adjacent to the cell of interest (Ct) in the transmission direction of the electromagnetic waves instead of the Doppler velocity indicated by the velocity data of the adjacent cell (Cb1) in the determination procedure.

The data processor module (17) performs determination procedure and correction processing whenever the velocity data of one cell (C) is stored in the storage module (16) by the speed data generation module (15B). More specifically, when the velocity data of the cell (C) of the m-th row and n-th column is stored in the storage module (16) by the speed data generation module (15B), the data processor module (17) determines whether the cell (C) of a (m-1) row and n-th column corresponds to the boundary cell (Cx) based on the velocity data of the cell (C) of the m-th row and n-th column, the velocity data of the cell (C) of the (m-1) row and n-th column in the storage module (16), and the velocity data of the cell (C) of the (m-1) row and (n-1) column in the storage module (16). Here, n and m are integers equal to or greater than 2. The first row shall be the row on the most ship’s (1) side.

When the determination procedure and the correction processing for one cell (C) are completed, the data processor module (17) outputs the amplitude data of the cell (C) after the correction processing to the display processor module (18). When the determination procedure and the correction processing for the nth column cell (C) are completed, the data processor module (17) deletes the amplitude data and the velocity data of the (n-1) th column cell (C) from the storage module (16). The data processor module (17) waits for the velocity data of the cell (C) belonging to the (n+1) th column to be stored in the storage module (16) by the speed data generation module (15B). The data processor module (17) may be configured to perform the determination procedure and the correction processing each time the velocity data of one cell (C) is stored in the storage module (16) by the speed data generation module (15B), and to output the amplitude data of one column of cell (C) after the correction processing to the display processor module (18) after the completion of the determination procedure and the correction processing for one column of cell (C).

The display processor module (18) receives the amplitude data from the data processor module (17), generates an echo image based on the received amplitude data, and performs a process of displaying the generated echo image on a display device (not shown). More specifically, the display processor module (18) updates the echo image displayed on the display device based on the received amplitude data each time it receives the amplitude data of one column of cells (C) from the data processor module (17). Accordingly, by displaying the echo image generated based on the corrected amplitude data, the plurality of target objects (S) in close proximity may be separated and displayed.

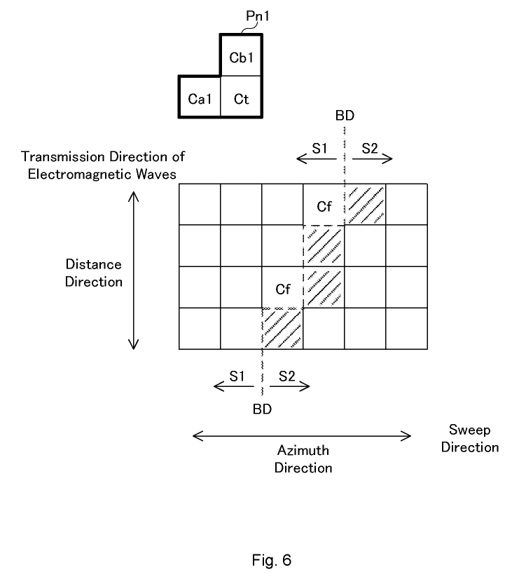

FIG. 6 is a diagram showing an example of the determination procedure and a correction processing by the data processor module (17) in the radar apparatus (101), according to an embodiment of the present invention. The thick frame in FIG. 6 shows a reference pattern (Pn1) showing the positional relationship between the cell of interest (Ct) in the determination procedure and adjacent cells (Ca1) and (Cb1) referred to in the determination procedure. FIG. 6 shows a portion of the cells (C) corresponding to the boundary portions of the target objects (S1) and (S2) among the plurality of cells (C) corresponding to the radar detection range (Ta) when the target objects (S1) and (S2) are close together as shown in FIG. 2. The dashed line in FIG. 6 shows a boundary (BD) of the actual target objects (S1) and (S2) when the echo image is displayed based on the amplitude data for each cell (C). The cell (C) hatched in FIG. 6 shows the cell (C) which is determined by the data processor module (17) to correspond to the boundary cell (Cx) in the determination procedure and whose amplitude indicated by the amplitude data is corrected to 0 in the correction processing.

Referring to FIG. 6, the data processor module (17) determines the cell (C) in the vicinity of the boundary (BD) to be the boundary cell (Cx) by performing the determination procedure and the correction process, and may correct the amplitude indicated by the amplitude data of the boundary cell (Cx) to 0. Thus, the user of the radar apparatus (101) may distinguish and recognize the target objects (S1) and (S2) displayed in the echo image based on the amplitude data after the correction process.

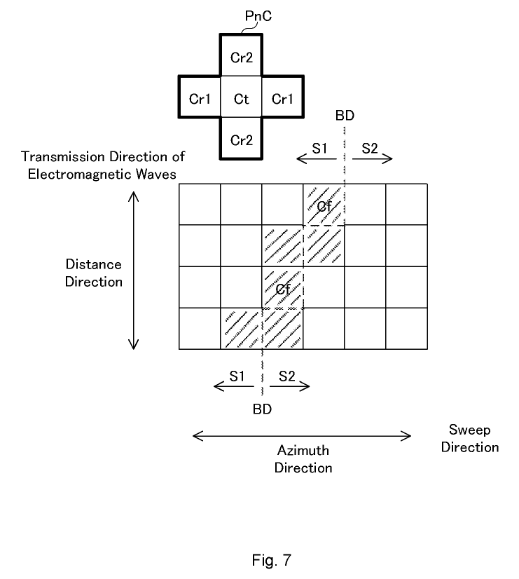

FIG. 7 is a diagram showing an example of the determination procedure and the correction processing by the radar apparatus (101), according to a comparative example of the present invention. The thick frame in FIG. 7 shows a reference pattern (PnC) showing the positional relationship between the cell of interest (Ct) and adjacent cells (Cr1) and (Cr2) in the processing of the radar apparatus (101) according to the comparative example. FIG. 7 shows a portion of the cells (C) corresponding to the boundary portions of the target objects (S1) and (S2) as in FIG. 6. The hatched cells (C) in FIG. 7 show the cells (C) whose amplitudes indicated by the amplitude data are attenuated to zero by the radar apparatus (101) described in Reference 1. The radar apparatus (101) described in Reference 1 performs processing to attenuate the amplitudes indicated by the amplitude data of the cell of interest (Ct) to zero when the difference of the Doppler velocities corresponding to two adjacent cells (Cr1) adjacent to each other across the cell of interest (Ct) in the azimuthal direction is not less than the predetermined value or when the difference of the Doppler velocities corresponding to two adjacent cells (Cr2) adjacent to each other across the cell of interest (Ct) in the distance direction is not less than the predetermined value.

Referring to FIG. 7, the radar apparatus (101) described in Reference 1 may attenuate the amplitudes indicated by the amplitude data of the cell (C) in the vicinity of the boundary (BD) to zero. However, since the radar apparatus (101) described in Reference 1 needs to use Doppler velocities corresponding to 3 columns of cell (C), it is necessary to store at least 3 columns of amplitude data and velocity data of cell (C) in the storage module (16).

In addition, the radar apparatus (101) described in Reference 1 attenuates the amplitude indicated by the amplitude data of a leading edge cell (Cf), which is the leading edge cell (Cf) on the ship (1) side of the target object (S1) in the distance direction, to 0. Therefore, in the echo image displayed on the basis of the amplitude data after processing, the user recognizes that the boundary (BD) on the ship (1) side of the target object (S1) is located further from the ship (1) by the amount of the leading edge cell (Cf). When the distance between the ship (1) and the target object (S1) is calculated on the basis of the amplitude data after processing, the distance between the ship (1) and the target object (S) is calculated to be larger than the actual value by the amount of the leading edge cell (Cf).

On the other hand, in the radar apparatus (101), according to the embodiment of the present invention, the data processor module (17) performs determination procedure using the velocity data of the cells (C) of the two columns, and since the amplitude data and the velocity data of the cells (C) of the past one column are deleted from the storage module (16) every time the determination procedure is performed, the amplitude data and the velocity data of the cells (C) of the two columns may be stored in the storage module (16).

In addition, as shown in FIG. 6, in the determination procedure, the data processor module (17) judges that the cell (C) of the trailing edge of the target object (S2) located in front of the ship (1) is the boundary cell (Cx) without judging that the leading edge cell (Cf) is the boundary cell (Cx). Therefore, the user may more correctly recognize the boundary (BD) of the ship (1) side of the target object (S1) in the echo image displayed by the display processor module (18). Based on the amplitude data after the correction processing, the distance between the ship (1) and the target object (S1) may be more accurately calculated.

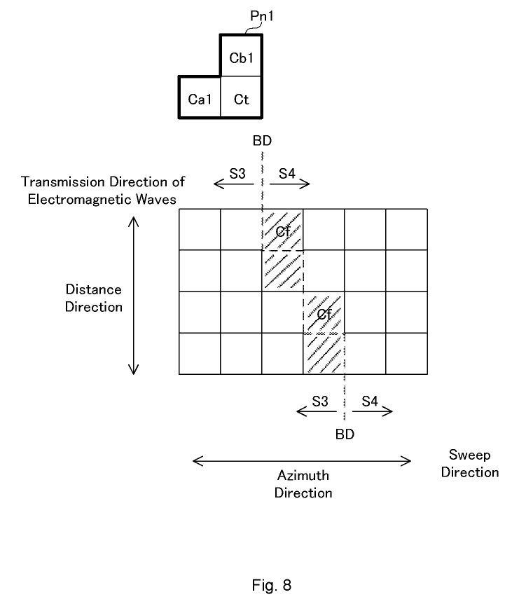

In another example of the boundary (BD) of the target object (S), FIGS. 8 to 11 are diagrams showing another example of the determination procedure and the correction processing by the data processor module (17) in the radar apparatus (101), according to the embodiment of the present invention.

FIG. 8 shows a portion of the cells (C) corresponding to the boundary portions of the target objects (S3) and (S4) among the plurality of cells (C) corresponding to the radar detection range (Ta) when the target objects (S3) and (S4) are close to each other. The dashed line in FIG. 8 shows the boundary (BD) of the actual target objects (S3) and (S4) when the echo image is displayed based on the amplitude data of each cell (C).

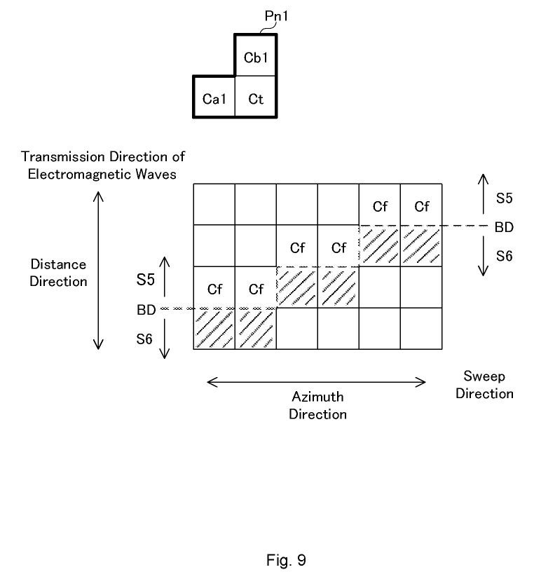

FIG. 9 shows a portion of the cells (C) corresponding to the boundary portion of the target objects (S5) and (S6) among the plurality of cells (C) corresponding to the radar detection range (Ta) when the target objects (S5) and (S6) are close to each other. The dashed line in FIG. 9 shows the boundary (BD) of the actual target objects (S5) and (S6) when the echo image is displayed based on the amplitude data of each cell (C).

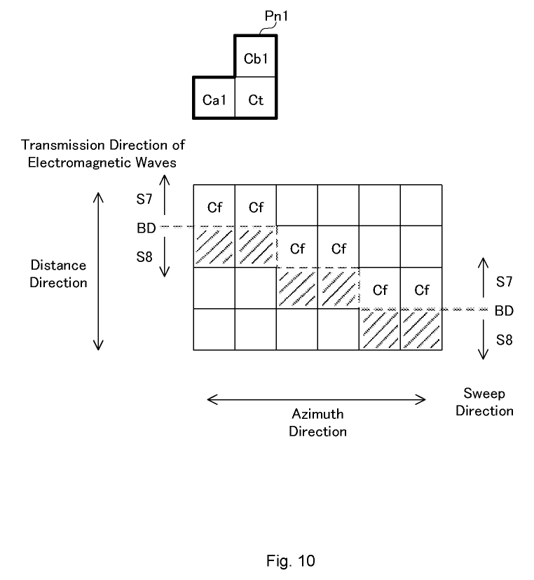

FIG. 10 shows a portion of the cells (C) corresponding to the boundary portions of the target objects (S7) and (S8) among the plurality of cells (C) corresponding to the radar detection range (Ta) when the target objects (S7) and (S8) are close to each other. The dashed line in FIG. 10 shows the boundary (BD) of the actual target objects (S7) and (S8) when the echo image is displayed based on the amplitude data for each cell (C).

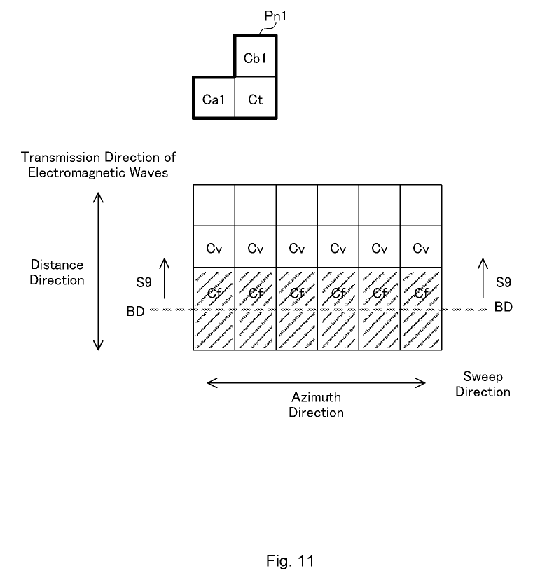

FIG. 11 shows a portion of the cells (C) corresponding to the boundary portion on the ship (1) side of the target object (S9) among the plurality of cells (C) corresponding to the radar detection range (Ta). Referring to FIG. 11, the velocity data of a cell (Cv) adjacent to the leading edge cell (Cf) of the target object (S9) in the transmission direction of the radar includes noise and may not be stable.

Referring to FIGS. 8 to 10, the data processor module (17) determines that the leading edge cell (Cf) of the target object (S4) is the boundary cell (Cx) in the arrangement of the target objects (S3) and (S4). However, in the arrangement of the target objects (S5) and (S6) and the arrangement of the target objects (S7) and (S8), the data processor module (17) determines that the cell (C) of the trailing edge of the target objects (S6) and (S8) located in front of the ship (1) is the boundary cell (Cx) without determining that the leading edge cell (Cf) of the target objects (S5) and (S7) is the boundary cell (Cx). Therefore, the boundary (BD) of the ship’s (1) side of the target objects (S5) and (S7) may be more correctly recognized in the echo image displayed by the display processor module (18). The distance between the ship (1) and the target objects (S5) and (S7) may be more accurately calculated based on the amplitude data after the correction processing.

Referring to FIG. 11, when the difference between the Doppler velocity indicated by the velocity data of the leading edge cell (Cf) of the target object (S9) and the Doppler velocity indicated by the velocity data of the cell (Cv) is equal to or greater than the predetermined value, the data processor module (17) may determine that the leading edge cell (Cf) of the target object (S9) is a boundary cell (Cx).

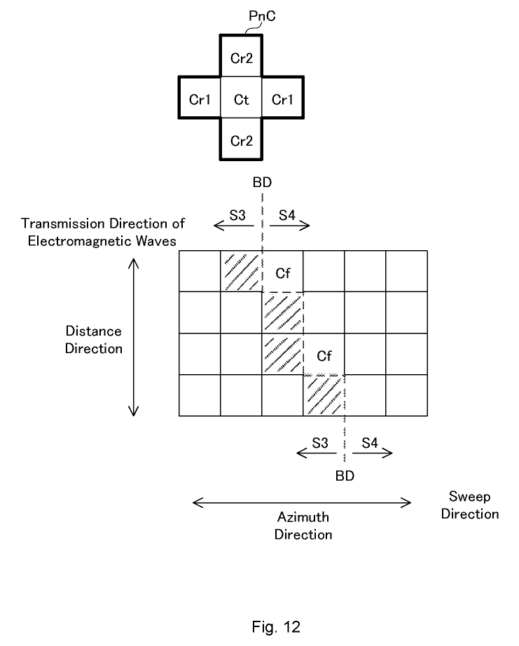

FIGS. 12 to 15 are diagrams showing other examples of the determination procedure and correction processing by the data processor module (17) in the radar apparatus (101), according to the comparative example of the present invention.

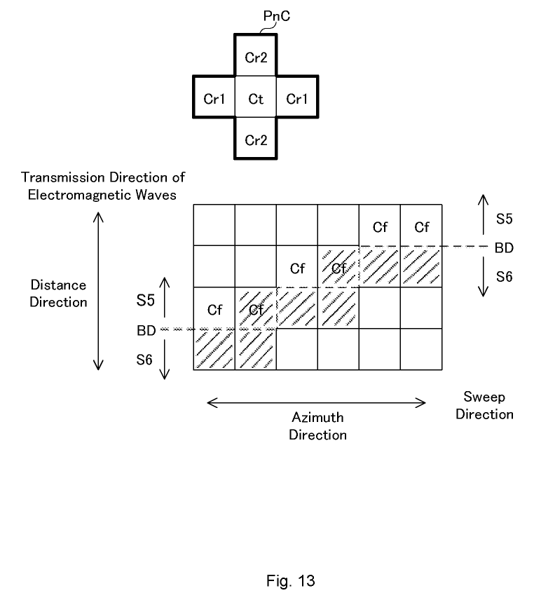

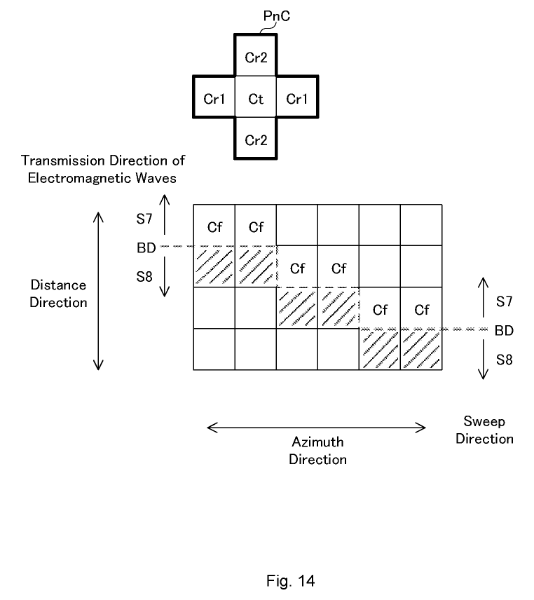

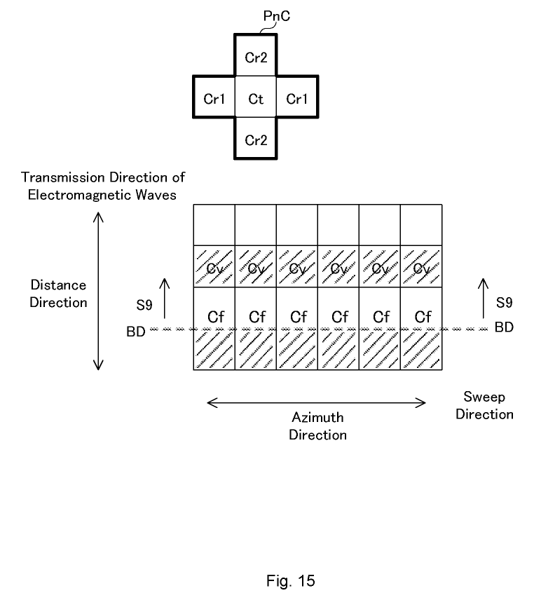

FIG. 12 shows the portion of the cells (C) corresponding to the boundary portions of the target objects (S3) and (S4) in the same manner as FIG. 8. FIG. 13 shows the portion of the cells (C) corresponding to the boundary portions of the target objects (S5) and (S6) as in FIG. 9. FIG. 14 shows the portion of the cells (C) corresponding to the boundary portions of the target objects (S7) and (S8) as in FIG. 10. FIG. 15 shows the portion of the cells (C) corresponding to the boundary portions on the ship’s (1) side of the target object (S9) as in FIG. 11.

Referring to FIGS. 12 to 14, the radar apparatus (101) described in Reference 1 does not perform a process to attenuate the amplitude indicated by the amplitude data of the leading edge cells (Cf) of the target objects (S4) and (S7) to 0, but performs the process to attenuate the amplitude indicated by the amplitude data of the leading edge cells (Cf) of the target object (S5) to 0.

Referring to FIG. 15, when the difference between the Doppler velocity indicated by the velocity data of the leading edge cells (Cf) of the target object (S9) and the Doppler velocity indicated by the velocity data of the cells (Cv) is equal to or greater than the predetermined value, the radar apparatus (101) described in Reference 1 may not perform the process to attenuate the amplitude indicated by the amplitude data of the leading edge cells (Cf) to 0, but performs the process to attenuate the amplitude indicated by the amplitude data of the cells (Cv) to 0. Therefore, in the echo image, the target object (S9) may be split in two, or processing using the amplitude data of the subsequent unit may be hindered.

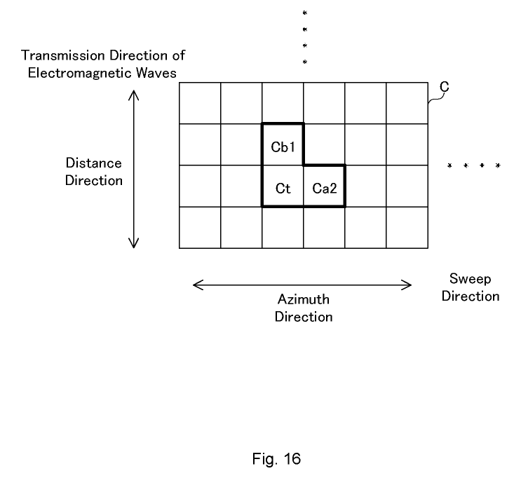

Another example of the determination procedure 1, FIG. 16 is a diagram for explaining another example of the determination procedure by the data processor module (17) in the radar apparatus (101), according to the embodiment of the present invention. Referring to FIG. 16, in the determination procedure, the data processor module (17) may use the velocity data of the adjacent cell (Ca2), which is the cell (C) adjacent to the cell of interest (Ct) in the sweep direction, instead of the adjacent cell (Ca1).

More specifically, the data processor module (17) compares the velocity data of the cell of interest (Ct) with the velocity data of the adjacent cell (Ca2), and compares the velocity data of the cell of interest (Ct) with the velocity data of the adjacent cell (Cb1). If the absolute value of the difference between the Doppler velocity indicated by the velocity data of the cell of interest (Ct) and the Doppler velocity indicated by the velocity data of the adjacent cell (Ca2) is not less than the predetermined value, or if the absolute value of the difference between the Doppler velocity indicated by the velocity data of the cell of interest (Ct) and the Doppler velocity indicated by the velocity data of the adjacent cell (Cb1) is not less than the predetermined value, the data processor module (17) determines that the cell of interest (Ct) corresponds to the boundary cell (Cx).

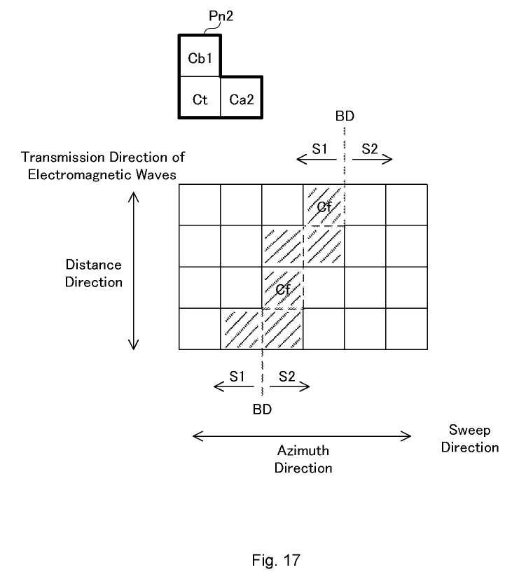

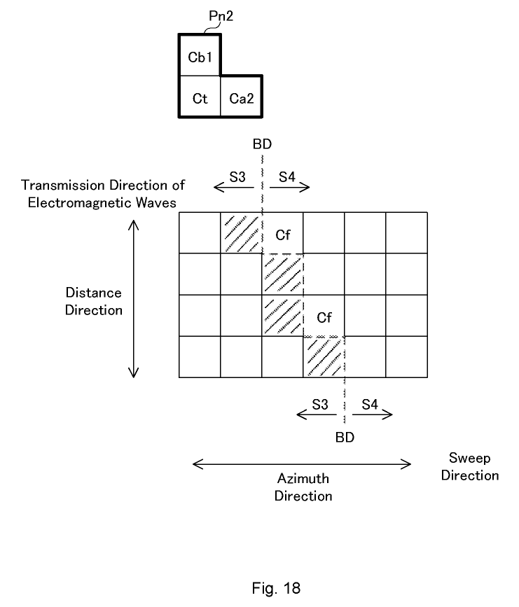

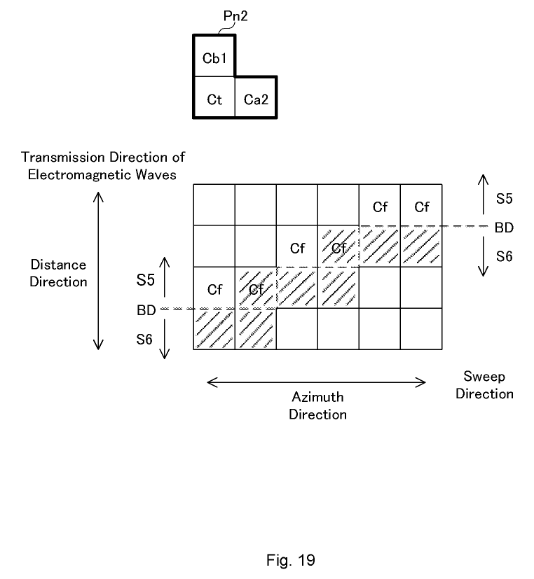

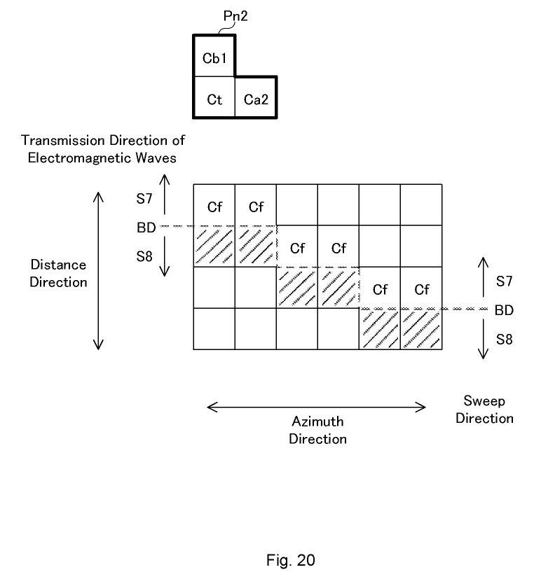

FIGS. 17 to 20 are views showing an example of a determination procedure and a correction processing by the data processor module (17) in the radar apparatus (101), according to an embodiment of the present invention. A thick frame in FIGS. 17 to 20 shows a reference pattern (Pn2) showing a positional relationship between the cell of interest (Ct) in the determination procedure and adjacent cells (Ca2) and (Cb1) referred to in the determination procedure. FIG. 17 shows the portion of the cell (C) corresponding to the boundary portion of target object (S1) and (S2) as in FIG. 6. FIG. 18 shows the portion of the cell (C) corresponding to the boundary portion of target objects (S3) and (S4) as in FIG. 8. FIG. 19 shows the portion of the cell (C) corresponding to the boundary portion of target objects (S5) and (S6) as in FIG. 9. FIG. 20 shows the portion of the cell (C) corresponding to the boundary portion of target objects (S7) and (S8) as in FIG. 10.

Referring to FIGS. 17 to 20, when velocity data of the adjacent cell (Ca2) is used instead of the adjacent cell (Ca1), the data processor module (17) determines that the leading edge cell (Cf) of target objects (S1) and (S5) is the boundary cell (Cx) in the arrangement of target objects (S1) and (S2) and the arrangement of target objects (S5) and (S6). However, when velocity data of the adjacent cell (Ca2) is used instead of the adjacent cell (Ca1), the data processor module (17) determines that the cell (C) of the trailing edge of target objects (S3) and (S8) located in front of the ship (1) is the boundary cell (Cx) without determining that the leading edge cell (Cf) of target objects (S4) and (S7) is the boundary cell (Cx) in the arrangement of target objects (S3) and (S4) and the arrangement of target objects (S7) and (S8). Therefore, the boundary (BD) of the ship’s (1) side of target objects (S4) and (S7) may be correctly recognized in the echo image displayed by the display processor module (18).

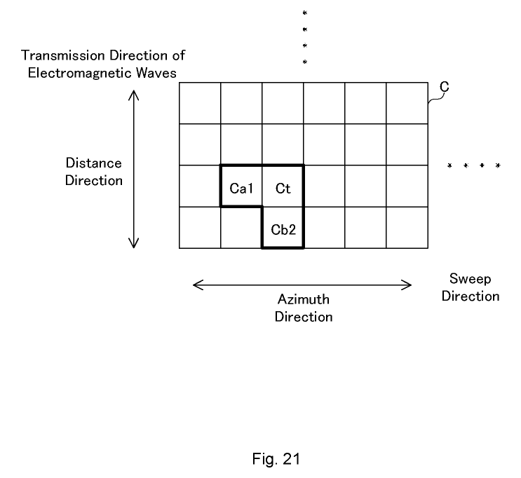

FIG. 21 is a diagram for explaining another example of the determination procedure by the data processor module (17) in the radar apparatus (101), according to the embodiment of the present invention. Referring to FIG. 21, the data processor module (17) may use the velocity data of the adjacent cell (Cb2), which is the cell (C) adjacent to the cell of interest (Ct) in the direction opposite to the transmission direction of the electromagnetic waves, instead of the adjacent cell (Cb1) in the determination procedure.

More specifically, the data processor module (17) compares the velocity data of the cell of interest (Ct) with the velocity data of the adjacent cell (Ca1), and compares the velocity data of the cell of interest (Ct) with the velocity data of the adjacent cell (Cb2). If the absolute value of the difference between the Doppler velocity indicated by the velocity data of the cell of interest (Ct) and the Doppler velocity indicated by the velocity data of the adjacent cell (Ca1) is not less than the predetermined value, or if the absolute value of the difference between the Doppler velocity indicated by the velocity data of the cell of interest (Ct) and the Doppler velocity indicated by the velocity data of the adjacent cell (Cb2) is not less than the predetermined value, then the data processor module (17) determines that the cell of interest (Ct) corresponds to the boundary cell (Cx).

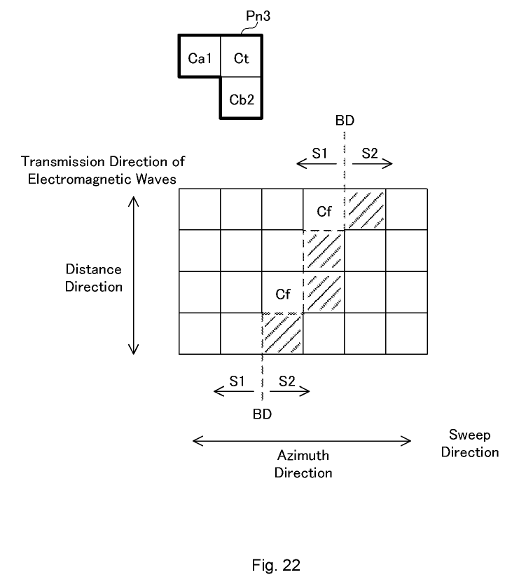

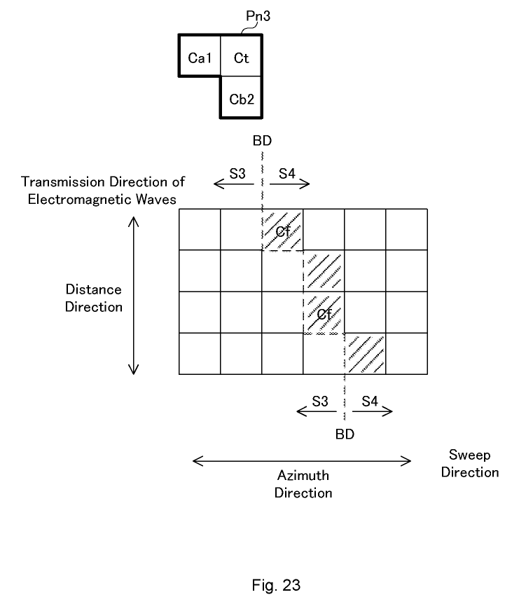

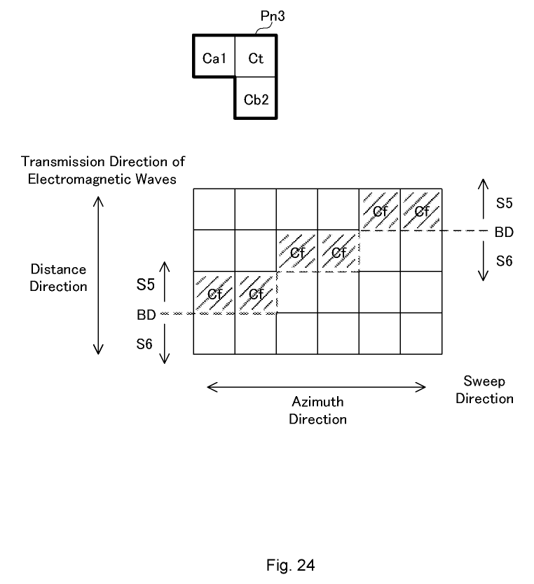

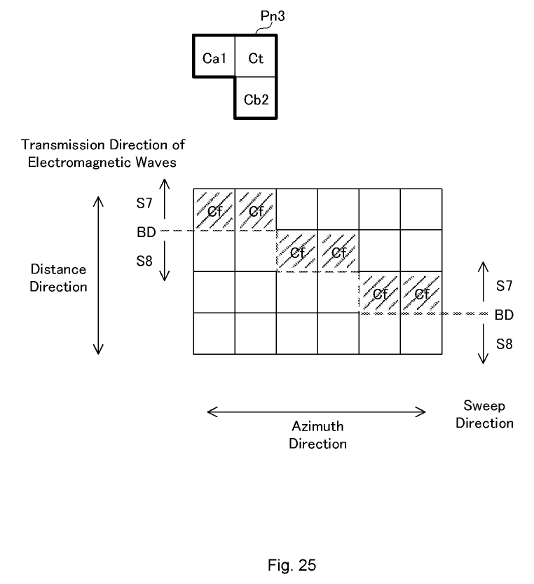

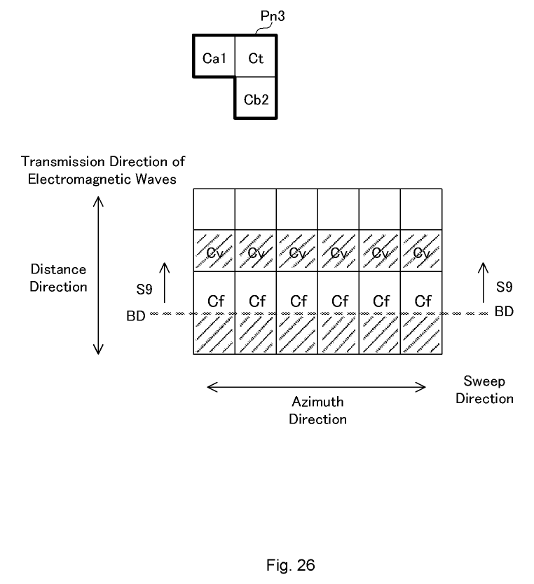

FIGS. 22 to 26 are views showing an example of the determination procedure and the correction processing by the data processor module (17) in the radar apparatus (101), according to an embodiment of the present invention. A thick frame in FIGS. 22 to 26 shows the reference pattern (Pn3) showing a positional relationship between the cell of interest (Ct) in the determination procedure and adjacent cells (Ca1) and (Cb2) referred to in the determination procedure. FIG. 22 shows the portion of the cell (C) corresponding to the boundary portion of target objects (S1) and (S2) as in FIG. 6. FIG. 23 shows the portion of the cell (C) corresponding to the boundary portion of target objects (S3) and (S4) as in FIG. 8. FIG. 24 shows the portion of the cell (C) corresponding to the boundary portion of target objects (S5) and (S6) as in FIG. 9. FIG. 25 shows the portion of the cell (C) corresponding to the boundary portion of target objects (S7) and (S8) as in FIG. 10. FIG. 26 shows the portion of the cell (C) corresponding to the boundary portion on the ship’s (1) side of target object (S9) as shown in FIG. 11.

Referring to FIGS. 22 to 26, when the velocity data of the adjacent cell (Cb2) is used instead of the adjacent cell (Cb1), the data processor module (17) determines that the leading edge cell (Cf) of the target objects (S4), (S5), and (S7) is the boundary cell (Cx) in the arrangement of the target objects (S3) and (S4), the arrangement of the target objects (S5) and (S6), and the arrangement of the target objects (S7) and (S8). In addition, when the velocity data of the adjacent cell (Cb2) is used instead of the adjacent cell (Cb1), the data processor module (17) determines that the cell (Cv) is the boundary cell (Cx) when the difference between the Doppler velocity data of the leading edge cell (Cf) of the target object (S9) and the Doppler velocity data of the cell (Cv) is equal to or greater than the predetermined value, so that the target object (S9) is split into two in the echo image or processing using the amplitude data in the subsequent unit may be hindered. However, when the velocity data of the adjacent cell (Cb2) is used instead of the adjacent cell (Cb1), the data processor module (17) determines that the cell (C) of the trailing edge of the target object (S2) is located in front of the ship (1) is the boundary cell (Cx) without determining that the leading edge cell (Cf) of the target object (S1) is the boundary cell (Cx) in the arrangement of the target objects (S1) and (S2). Therefore, the boundary (BD) of the ship’s (1) side of the target object (S2) may be more correctly recognized in the echo image displayed by the display processor module (18).

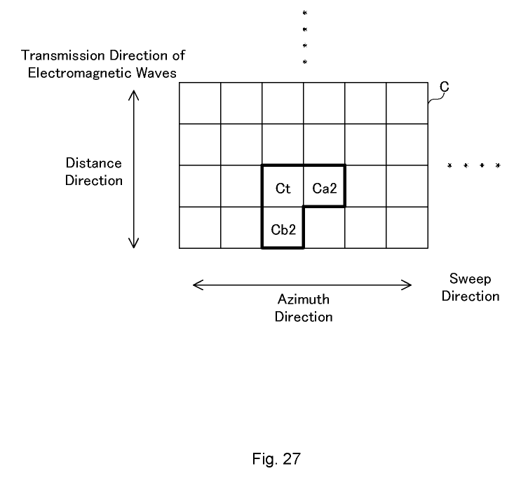

FIG. 27 is a diagram for explaining another example of the determination procedure by the data processor module (17) in the radar apparatus (101), according to the embodiment of the present invention. Referring to FIG. 27, the data processor module (17) may use the velocity data of the adjacent cells (Ca2), (Cb2) instead of the adjacent cells (Ca1), (Cb1) in the determination procedure.

More specifically, the data processor module (17) compares the velocity data of the cell of interest (Ct) with the velocity data of the adjacent cell (Ca2), and compares the velocity data of the cell of interest (Ct) with the velocity data of the adjacent cell (Cb2). If the absolute value of the difference between the Doppler velocity indicated by the velocity data of the cell of interest (Ct) and the Doppler velocity indicated by the velocity data of the adjacent cell (Ca2) is not less than the predetermined value, or if the absolute value of the difference between the Doppler velocity indicated by the velocity data of the cell of interest (Ct) and the Doppler velocity indicated by the velocity data of the adjacent cell (Cb2) is not less than the predetermined value, the data processor module (17) determines that the cell of interest (Ct) corresponds to the boundary cell (Cx).

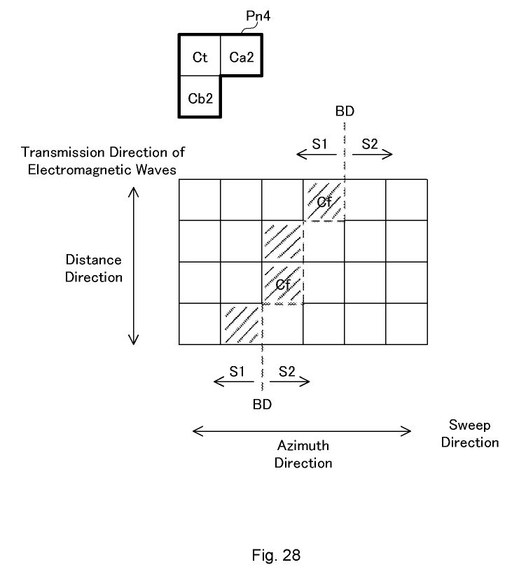

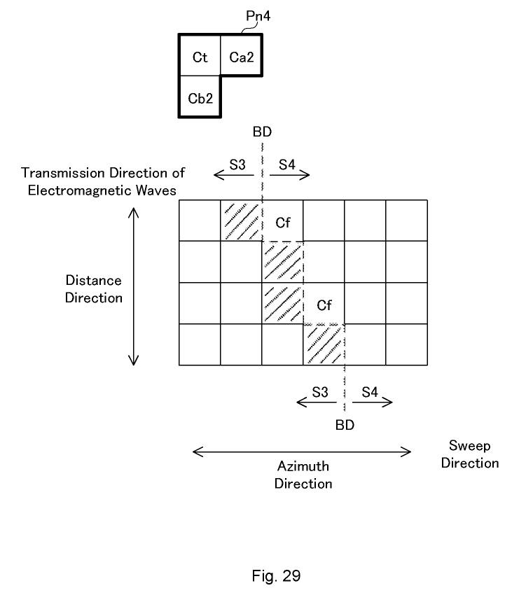

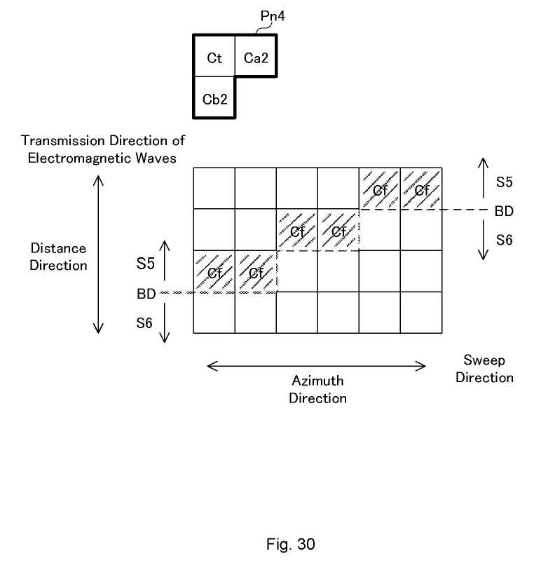

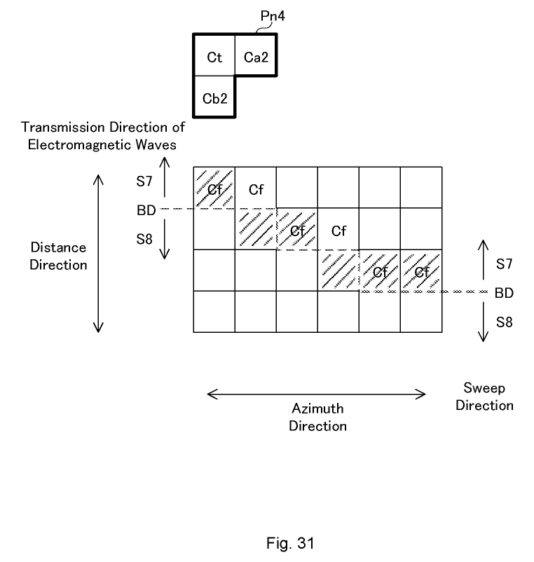

FIGS. 28 to 31 are views showing an example of the determination procedure and the correction processing by the data processor module (17) in the radar apparatus (101), according to an embodiment of the present invention. A thick frame in FIGS. 28 to 31 shows a reference pattern (Pn4) showing a positional relationship between the cell of interest (Ct) in the determination procedure and adjacent cells (Ca2) and (Cb2) referred to in the determination procedure. FIG. 1 is the diagram showing an example of determination procedure and correction processing by the data processor module (17) in the radar apparatus (101), according to an embodiment of the present invention. FIG. 28 shows the portion of a cell (C) corresponding to the boundary portion of target objects (S1) and (S2) in the same manner as FIG. 6. FIG. 29 shows the portion of a cell (C) corresponding to the boundary portion of target objects (S3) and (S4) in the same manner as FIG. 8. FIG. 30 shows the portion of the cell (C) corresponding to the boundary portion of target objects (S5) and (S6) in the same manner as FIG. 9. FIG. 31 shows the portion of the cell (C) corresponding to the boundary portion of target objects (S7) and (S8) in the same manner as FIG. 10.

Referring to FIGS. 28 to 31, when velocity data of adjacent cells (Ca2) and (Cb2) are used instead of adjacent cells (Ca1) and (Cb1), the data processor module (17) determines that the leading edge cell (Cf) of target objects (S1), (S5), and (S7) is the boundary cell (Cx) in the arrangement of target objects (S1) and (S2), the arrangement of target objects (S5) and (S6), and target objects (S7) and (S8). However, when velocity data of adjacent cells (Ca2) and (Cb2) are used instead of adjacent cells (Ca1) and (Cb1), the data processor module (17) determines that the cell (C) of the trailing edge of target object (S3) located in front of the ship (1) is the boundary cell (Cx) without determining that the leading edge cell (Cf) of target object (S4) is the boundary cell (Cx) in the arrangement of target objects (S3) and (S4). Therefore, the boundary (BD) of the ship’s (1) side of target object (S4) may be correctly recognized in the echo image displayed by the display processor module (18).

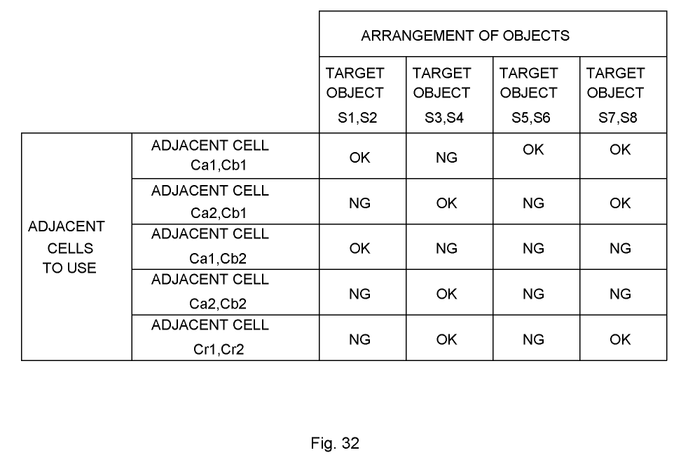

Comparison of Reference Patterns used in Judgement processing - FIG. 32 is a diagram showing the superiority and inferiority according to the adjacent cells used in the determination procedure by the data processor module (17) in the radar apparatus (101), according to the embodiment of the present invention. In FIG. 32, “OK ” indicates a case where the cell (C) at the trailing edge of the target object (S) located in front of the ship (1) is determined to be the boundary cell (Cx), and the amplitude data of the cell (C) at the trailing edge is attenuated to 0. In FIG. 32, “NG ” indicates a case where the leading edge cell (Cf) is determined to be the boundary cell (Cx) and the amplitude indicated by the amplitude data of the leading edge cell (Cf) is attenuated to 0.

Referring to FIG. 32, from the results of the determination procedure in the four variations of the arrangement of two target objects (S) in close proximity, it may be seen that it is preferable to use adjacent cells (Ca1) and (Cb1) in the determination procedure.

In addition, when the data processor module (17) uses the adjacent cell (Ca2) instead of the adjacent cell (Ca1) in the determination procedure, each time the velocity data of the cell (C) in the nth column is stored in the storage module (16) by the speed data generation module (15B), it may be necessary to determine whether the cell (C) in the (n-1) column corresponds to the boundary cell (Cx) based on the velocity data of the cell (C) in the nth column and the velocity data of the cell (C) in the (n-1) column in the storage module (16).

Flow of Operation - The radar apparatus (101), according to the embodiment of the present invention, includes a computer including a memory, and a processor such as a CPU in the computer reads out a program including a part or all of the steps of the following flowchart from the memory and executes the program. The program of the apparatus may be installed externally. The program of the apparatus is distributed in a state stored in a recording medium or through a communication line.

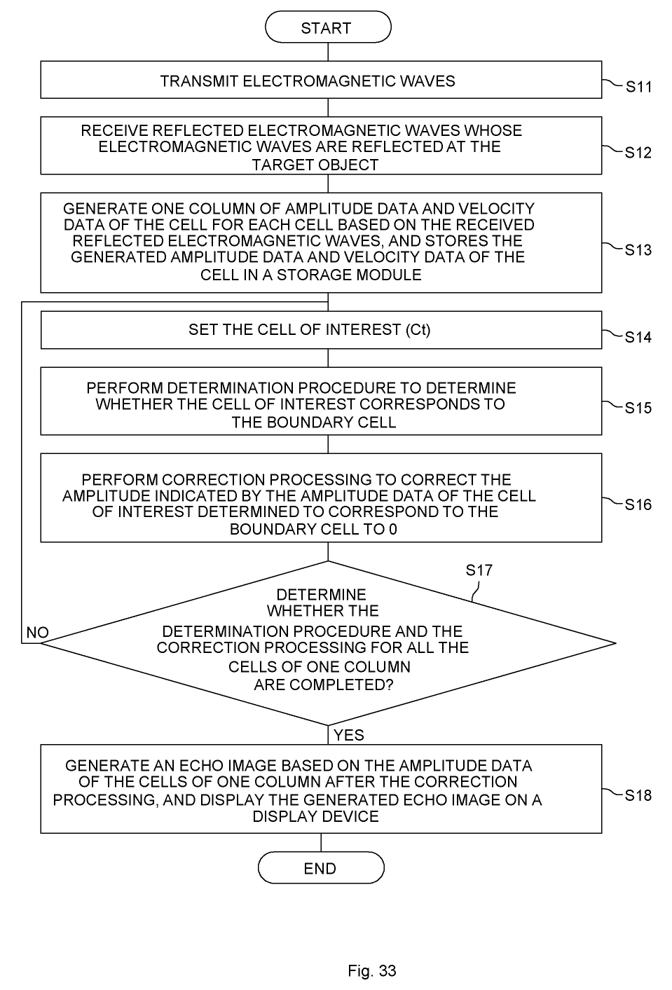

FIG. 33 is a flowchart showing an example of an operation in which the radar apparatus (101) performs the processing for displaying an echo image, according to an embodiment of the present invention. For example, the radar apparatus (101) performs the processing shown in the flowchart of FIG. 33 for each sweep period (T).

Referring to FIG. 33, the radar apparatus (101) first transmits electromagnetic waves (step S11).

Further, the radar apparatus (101) receives reflected electromagnetic waves whose electromagnetic waves are reflected at the target object (S) (step S12).

Further, the radar apparatus (101) generates one column of amplitude data and velocity data of the cell (C) for each cell (C) based on the received reflected electromagnetic waves, and stores the generated amplitude data and velocity data of the cell (C) in the storage module (16) (step S13).

Further, the radar apparatus (101) sets the cell of interest (Ct) (step S14).

Next, the radar apparatus (101) performs determination procedure to determine whether the cell of interest (Ct) corresponds to the boundary cell (Cx) (step S15).

Next, the radar apparatus (101) performs correction processing to correct the amplitude indicated by the amplitude data of the cell of interest (Ct) determined to correspond to the boundary cell (Cx) to 0 (step S16).

Next, the radar apparatus (101) repeats the processing from step S14 to step S16 until the determination procedure and the correction processing for all the cells (C) of one column are completed (NO in step S17), and when the determination procedure and the correction processing for all the cells (C) of one column are completed (YES in step S17), the radar apparatus (101) generates the echo image based on the amplitude data of the cells (C) of one column after the correction processing, and displays the generated echo image on the display device (not shown) (step S18).

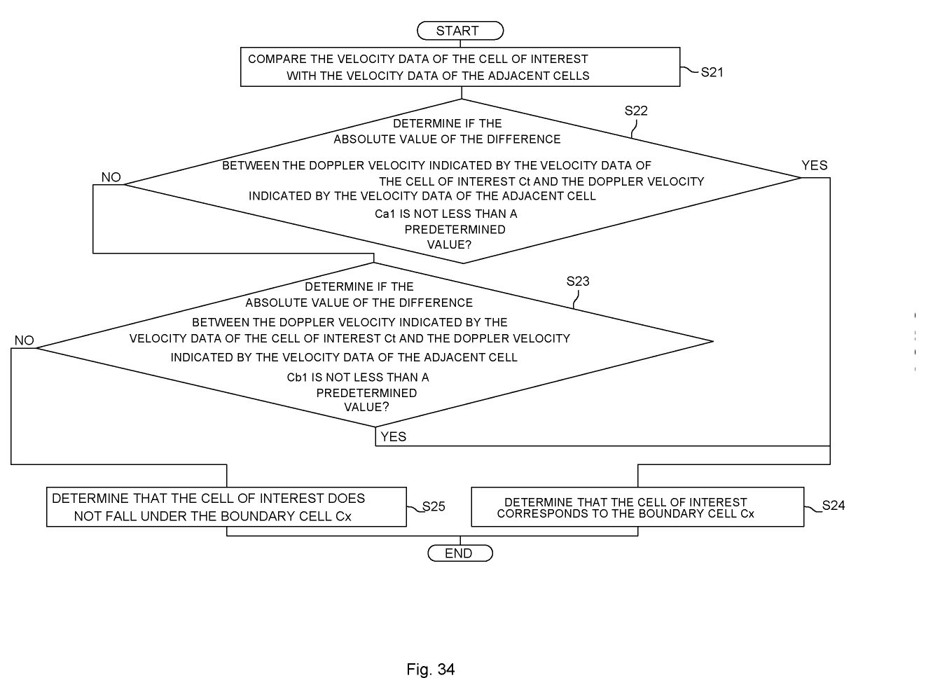

FIG. 34 is a flowchart showing an example of an operation in which the radar apparatus (101) performs determination procedure, according to an embodiment of the present invention. FIG. 34 shows details of step S15 in FIG. 33.

Referring to FIG. 34, the radar apparatus (101) first compares the velocity data of the cell of interest (Ct) with the velocity data of the adjacent cells (Ca1), (Cb1) (step S21).

Next, if the absolute value of the difference between the Doppler velocity indicated by the velocity data of the cell of interest (Ct) and the Doppler velocity indicated by the velocity data of the adjacent cell (Ca1) is not less than the predetermined value, or if the absolute value of the difference between the Doppler velocity indicated by the velocity data of the cell of interest (Ct) and the Doppler velocity indicated by the velocity data of the adjacent cell (Cb1) is not less than the predetermined value (YES in step S22 or YES in step S23), the radar apparatus (101) determines that the cell of interest (Ct) corresponds to the boundary cell (Cx) (step S24).

On the other hand, if the absolute value of the difference between the Doppler velocity indicated by the velocity data of the cell of interest (Ct) and the Doppler velocity indicated by the velocity data of the adjacent cell (Ca1) is less than the predetermined value and the absolute value of the difference between the Doppler velocity indicated by the velocity data of the cell of interest (Ct) and the Doppler velocity indicated by the velocity data of the adjacent cell (Cb1) is less than the predetermined value (NO in step S22 and NO in step S23), the radar apparatus (101) determines that the cell of interest (Ct) does not fall under the boundary cell (Cx) (step S25).

In the radar apparatus (101) according to the embodiment of the present invention, the data processor module (17) determines whether the cell of interest (Ct) corresponds to the boundary cell (Cx) on the basis of the comparison result between the velocity data of the cell of interest (Ct) and the velocity data of the adjacent cells (Ca1) and (Cb1) in the determination procedure, but this is not limited to the present invention. The data processor module (17) may further determine whether the cell of interest (Ct) corresponds to the boundary cell (Cx) on the basis of the comparison result between the amplitude data of the cell of interest (Ct) and the predetermined value. Specifically, the data processor module (17) determines that the cell of interest (Ct) corresponds to the boundary cell (Cx) when the amplitude indicated by the amplitude data of the cell of interest (Ct) is equal to or greater than the predetermined value, and when the absolute value of the difference between the Doppler velocity indicated by the velocity data of the cell of interest (Ct) and the Doppler velocity indicated by the velocity data of the adjacent cell (Ca1) is equal to or greater than the predetermined value, or when the absolute value of the difference between the Doppler velocity indicated by the velocity data of the cell of interest (Ct) and the Doppler velocity indicated by the velocity data of the adjacent cell (Cb1) is equal to or greater than the predetermined value. On the other hand, when the amplitude indicated by the amplitude data of the cell of interest (Ct) is less than the threshold value, the data processor module (17) determines that the cell of interest (Ct) may not fall under the boundary cell (Cx) regardless of the comparison result between the velocity data of the cell of interest (Ct) and the velocity data of the adjacent cells (Ca1), (Cb1).

In the radar apparatus (101), according to the embodiment of the present invention, the generation module (15) may include the amplitude data generation module (15A) instead of the speed data generation module (15B) or in addition to the speed data generation module (15B). The amplitude data generation module (15A) generates an acceleration data indicating the acceleration of the target object (S) at the position corresponding to the cell (C) based on the received data received from the receiving module (14). The acceleration data is an example of displacement data. In this case, the data processor module (17) determines whether the cell of interest (Ct) corresponds to the boundary cell (Cx) based on the comparison result between the acceleration data of the cell of interest (Ct) and the acceleration data of the cell (C) adjacent to the cell of interest (Ct) in the azimuthal direction, and the comparison result between the acceleration data of the cell of interest (Ct) and the acceleration data of the cell (C) adjacent to the cell of interest (Ct) in the distance direction in the determination procedure.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, "can", "could", "might" or "may" unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase "at least one of X, Y, or Z" unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as "a" or "an" should generally be interpreted to include one or more described items. Accordingly, phrases such as "a device configured to" are intended to include one or more recited devices. Such one or more recited devices can also be collectively configured to carry out the stated recitations. For example, "a processor configured to carry out recitations A, B and C" can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of "two recitations" without other modifiers, typically means at least two recitations, or two or more recitations).

It will be understood by those within the art that, in general, terms used herein, are generally intended as "open" terms (e.g., the term "including" should be interpreted as "including but not limited to" the term "having" should be interpreted as "having at least" the term "includes" should be interpreted as "includes but is not limited to" etc.).

For expository purposes, the term "horizontal" as used herein is defined as a plane parallel to the plane or surface of the floor of the area in which the system being described is used or the method being described is performed, regardless of its orientation. The term "floor" can be interchanged with the term "ground" or "water surface." The term "vertical" refers to a direction perpendicular to the horizontal as just defined. Terms such as "above", "below", "bottom", "top", "side", "higher", "lower", "upper", "over" and "under" are defined with respect to the horizontal plane.

As used herein, the terms "attached", "connected", "mated" and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as "approximately", "about" and "substantially" as used herein include the recited numbers, and also represent an amount close to the stated amount that still performs a desired function or achieves a desired result. For example, the terms "approximately", "about" and "substantially" may refer to an amount that is within less than 10% of the stated amount. Features of embodiments disclosed herein preceded by a term such as "approximately", "about" and "substantially" as used herein represent the feature with some variability that still performs a desired function or achieves a desired result for that feature.

The foregoing embodiments should be considered illustrative and not restrictive in all respects. It is intended that the scope of the present invention be indicated by the claims rather than the above description and include all changes within the meaning and scope of the claims and equivalence.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A radar apparatus comprising:
a transmitter configured to transmit electromagnetic waves;
a receiver configured to receive reflected electromagnetic waves reflected by a target object; and
processing circuitry configured to:
generate amplitude data of the reflected electromagnetic waves and displacement data indicating velocity or acceleration of a target object based on the reflected electromagnetic waves for each cell on a coordinate having an azimuthal direction and a distance direction; and
determine whether a cell of interest corresponds to a boundary cell to be a boundary to divide the target object based on a comparison result between the displacement data of the cell of interest among a plurality of cells of interest and the displacement data of the cell of interest being close to the cell of interest in the azimuthal direction or the distance direction.

2. The radar apparatus according to claim 1, wherein the processing circuitry is further configured to:
determine whether the cell of interest corresponds to the boundary cell on the basis of the comparison result between the displacement data of the cell of interest and the displacement data of the cell in proximity to the cell of interest in the azimuthal direction, and the comparison result between the displacement data of the cell of interest and the displacement data of the cell in proximity to the cell of interest in the distance direction.

3. The radar apparatus according to claim 2, wherein the processing circuitry is further configured to:
determine that the cell of interest corresponds to the boundary cell when the absolute value of the difference between the displacement data of the cell of interest and the displacement data of the cell adjacent to the cell of interest in the azimuthal direction is not less than a predetermined value, and the absolute value of the difference between the displacement data of the cell of interest and the displacement data of the cell adjacent to the cell of interest in the distance direction is not less than the predetermined value.

4. The radar apparatus according to claim 1, wherein
the transmitting module is further configured to repeatedly transmit the electromagnetic waves while changing the transmission direction of the electromagnetic waves along a first direction among the azimuthal directions, and wherein the processing circuitry is further configured to:
determine whether the cell of interest corresponds to the boundary cell based on the comparison result between the displacement data of the cell of interest and the displacement data of the cell adjacent to the cell of interest in a direction opposite to the first direction in a determination procedure.

5. The radar apparatus of claim 4, wherein the processing circuitry is further configured to:
determine, while changing the cell set as the cell of interest along a second direction among the distance directions, whether the cell of interest corresponds to the boundary cell based on the comparison result between the displacement data of the cell of interest, and the displacement data of the cell adjacent to the cell of interest in the second direction.

6. The radar apparatus according to claim 1, further comprising:
an attenuation module configured to attenuate the amplitude indicated by the amplitude data of the cell of interest determined to correspond to the boundary cell.

7. The radar apparatus according to claim 3, wherein
the transmitting module is further configured to repeatedly transmit the electromagnetic waves while changing the transmission direction of the electromagnetic waves along a first direction among the azimuthal directions, and wherein the processing circuitry is further configured to:
determine whether the cell of interest corresponds to the boundary cell based on the comparison result between the displacement data of the cell of interest and the displacement data of the cell adjacent to the cell of interest in a direction opposite to the first direction in a determination procedure.

8. The radar apparatus of claim 7, wherein the processing circuitry is further configured to:
determine, while changing the cell set as the cell of interest along a second direction among the distance directions, whether the cell of interest corresponds to the boundary cell based on the comparison result between the displacement data of the cell of interest, and the displacement data of the cell adjacent to the cell of interest in the second direction.

9. The radar apparatus according to claim 3, further comprising:
an attenuation module configured to attenuate the amplitude indicated by the amplitude data of the cell of interest determined to correspond to the boundary cell.

10. The radar apparatus according to claim 5, further comprising:
an attenuation module configured to attenuate the amplitude indicated by the amplitude data of the cell of interest determined to correspond to the boundary cell.

11. A data processing method comprising:
transmitting, by a transmitting module, electromagnetic waves;
receiving, by a receiving module, reflected electromagnetic waves reflected by a target object;
generating, by a generation module,
amplitude data of the reflected electromagnetic waves and
displacement data indicating velocity or acceleration of the target object based on the reflected electromagnetic waves for each cell on a coordinate having an azimuthal direction and a distance direction; and
determining, by a determination module, whether a cell of interest corresponds to a boundary cell to be a boundary to divide the target object based on a comparison result between the displacement data of the cell of interest among a plurality of cells of interest and the displacement data of the cell of interest being close to the cell of interest in the azimuthal direction or the distance direction.

12. A non-transient computer-readable recording medium, recording a data processing program, enabling a computer to:
transmit, by a transmitting module, electromagnetic waves;
receive, by a receiving module, reflected electromagnetic waves reflected by a target object;
generate, by a generation module,
amplitude data of the reflected electromagnetic waves and
displacement data indicating the velocity or acceleration of the target object based on the reflected electromagnetic waves for each cell on a coordinate having an azimuthal direction and a distance direction; and
determine, by a determination module, whether a cell of interest corresponds to a boundary cell to be a boundary to divide the target object based on a comparison result between the displacement data of the cell of interest among a plurality of cells of interest and the displacement data of the cell of interest being close to the cell of interest in the azimuthal direction or the distance direction.
